(19) United States
(12) Patent Application Publication
(10) Pub. No.: US 2021/0045376 A1
(43) Pub. Date: Feb. 18, 2021

(54) DEVICE FOR CATCHING INSECTS

(71) Applicant: Peter BLOM, Otterup (DK)

(72) Inventor: Peter BLOM, Otterup (DK)

(21) Appl. No.: 16/976,503

(22) PCT Filed: Feb. 27, 2019
(86) PCT No.: PCT/EP2019/054873

§ 371 Date: Aug. 28, 2020

(30) Foreign Application Priority Data
Mar. 1, 2018 (DK) PA201870137

(51) Int. Cl. A01M 1/16; A01K 13/00

(52) U.S. Cl. CPC A01M 1/16; A01M 2200/012; A01K 13/00

(57) ABSTRACT

There is provided a device for catching insects, such as flies. The device can be attached in an area having particular high activity of insects, such as in the vicinity of a horse eye. The device comprises a sheet having an outer surface with an adhesive layer for catching and holding insects contacting said adhesive. It also includes a holding member for holding the sheet and attaching to the animal. Preferably the sheet is releasable from the holding member.

### FIELD OF THE INVENTION

The present invention relates to a device for catching insect, such as flies. More specifically, the invention relates to a device that can be attached in areas with particular high concentration of insects, such as in the vicinity of a horse eye.

### BACKGROUND OF THE INVENTION

A number of known devices have a sheet or coating of adhesive or sticky material for catching insects. The purpose of these arrangements is to capture an insect, most often a fly, rather than to crush it as is the case with the common fly swatter. The advantages are, among others, that no damage is likely to occur to objects which would otherwise be struck by the striking type of swatter and that the insect is gathered up in its entirety rather than falling away or being squashed on a surface.

Examples of catcher designs with various forms of adhesive surfaces include U.S. Pat. No. 1,802,774 disclosing a plurality of superimposed sheets of adhesive coated paper; U.S. Pat. No. 2,437,447 showing an adhesive coated cup; U.S. Pat. No. 2,618,882 illustrating an adhesively coated perforated replaceable member; and U.S. Pat. No. 3,449,856 describing a transparent adhesively covered replaceable head.

Flies and mosquitos and other insects are a common source of irritation to animals such as horses. Irritation caused by insects often occurs around the eyes. Beyond causing annoyance to an animal, the presence of insects around an animal's eyes can be a cause of eye infection. Eye infections compromise the health of an animal's eyes and in severe cases blindness can occur.

It is well known that the egg production and thus the reproduction of insects, and in particular flies, increases significantly when protein nutrients are available. Since the concentration of proteins in eye liquid high there is a need to provide means to overcome the problems associated with especially flies when they have easy access to the eye region.

US20150366164 discloses a mask onto which an adhesive strip may be attached. In this respect horse fly masks are well known, where a transparent visor or a mesh material covers the eye region and retains flies and debris. In US20150366164 the mask has been modified with adhesive strips instead of the visor or mesh material.

It is an object of the present invention to provide a device that can efficiently trap the flies so as to prevent their access to the eye region of animals, such as horses and cattles. Moreover, it is an object to provide a device that is simple to mount on the animal, such as on a bridle, without inducing any irritation.

### SUMMARY OF THE INVENTION

The invention provides a device for reducing insect irritation of an animal. There is therefore provided a device for catching insects, such as flies. This device comprises a sheet having an exposed outer surface with an adhesive layer for catching and holding insects contacting said adhesive. The present invention utilizes the discovery that flies are very attracted to the eyes of an animal, preferably a horse, due to high protein concentration in this area. By placing the device close to the eyes of a horse a surprisingly high number are captured within a short period of time. This is a decisive measure when coping with flies due to their high proliferation rate. The present inventor has surprisingly found that when the device is placed in the vicinity of the eyes of a horse the number of flies and thus the irritation for the horse can be significantly reduced.

It also includes a holding member for holding the sheet and attaching to the animal. Preferably the sheet is releasable from the holding member. Most preferably the sheet is clickable or slidable onto the holding member but it could also be attached thereto by a Velcro lock, magnetic means or by a glue. By having a clickable solution as shown in the herein provided figures the use may easily change the sheet sheet without being contaminated by bacteria or other undesirable matters.

The holding member is preferably configured to be mounted onto a bridle, such as a cheek piece, of a horse in the vicinity of the eyes. The device of the present invention may either be incorporated with the traditional bridle of the horse or alternatively, a separate member could be utilized. In the latter alternative the holding member is preferably clickable onto the bridle. In the embodiment where the holding member (2) is clickable onto the bridle, the holding member (2) comprises an outer frame (4) for holding the sheet and an inner frame (5) for holding the holding member (2) in place on the bridle when the outer (4) and inner (5) frames are attached to each other, said inner (5) and outer (4) frames connected via a hinge (6). Preferably the holding member (2) is provided with protrusions having recesses (7) for clicking the sheet (1) onto the holding member (2). Further the holding member (2) is preferably provided with means (8) for securing the holding member (2) to the bridle when clamped around it.

It is preferred that the adhesive comprises a fragrance to attract insects. Moreover, the adhesive may comprise proteins to attract insects. Finally, the adhesive may incorporate an insecticide for killing insects becoming affixed to the adhesive.

### BRIEF DESCRIPTION OF THE DRAWINGS

FIG. 1 is a side perspective view of the invention showing the holding member and the sheet separately.

FIG. 2 shows the invention when the holding member and the sheet are assembled.

FIG. 3 is a cross sectional view of the present invention.

FIG. 4 shows the device of the present invention attached to a bridle of a horse in the vicinity of an eye.

### DETAILED DESCRIPTION OF THE INVENTION

The present invention relates to a device for reducing insect irritation which addresses the recurrent problem of insect irritation to the eyes and face of an animal. One of the things that makes this invention unique is the use adhesive sheet releasable from the holder that can be mounted on the bridle or be an integral part thereof.

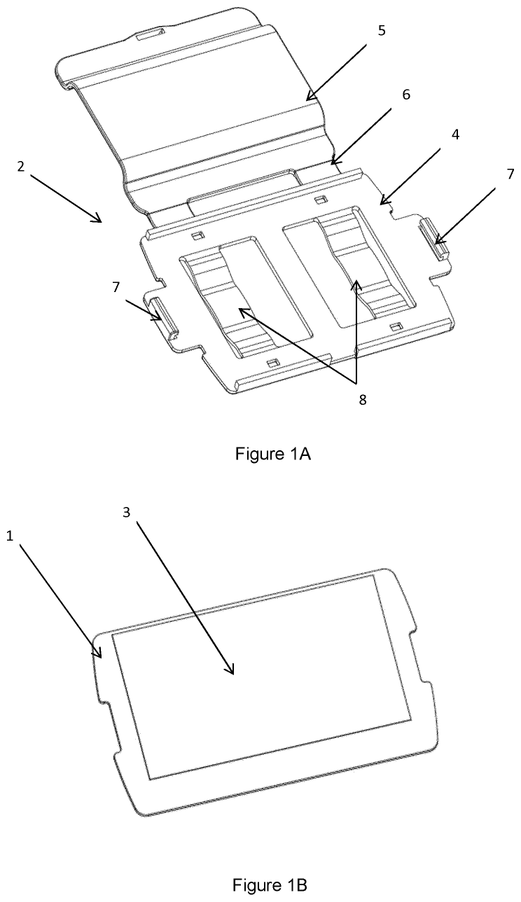

Referring to FIG. 1 there is shown the holding member and the sheet separately. As can be seen the sheet is preferably flat and quadratic with an evenly distributed layer of adhesive deposited on one side of the sheet. The adhesive may include further compounds such as proteins or other insect attractants.

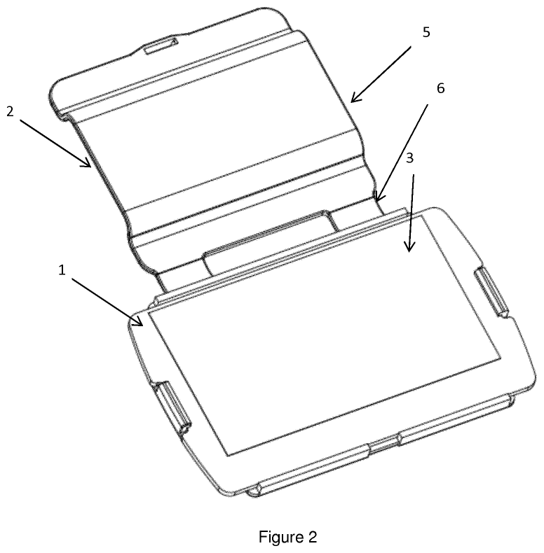

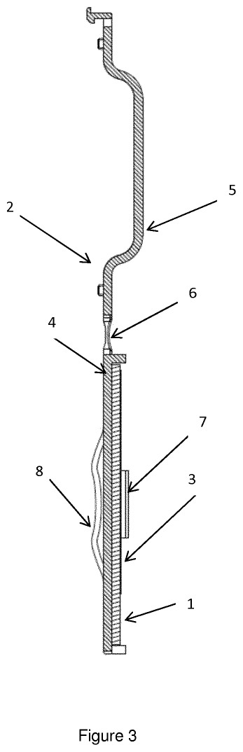

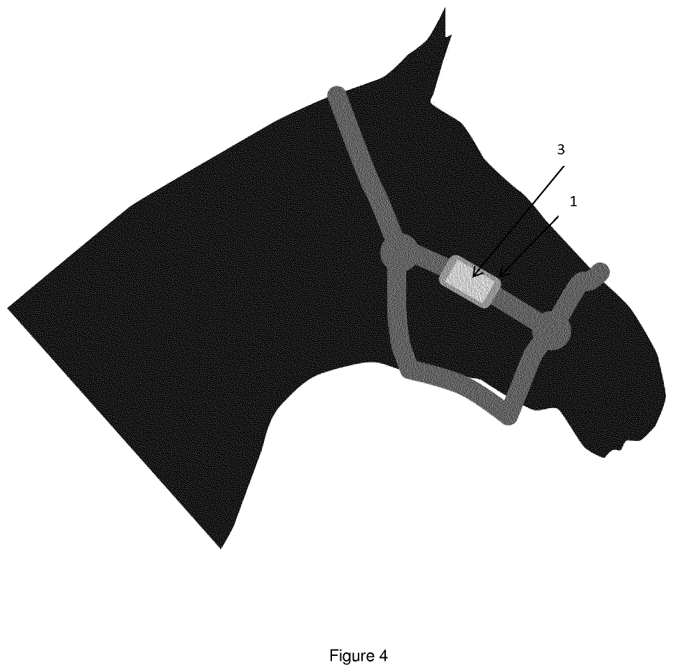

As appears from FIG. 1 the sheet (B) is preferably clickable onto the holder (A). However, it could also be attached to the holder via a track system (i.e. slideable). FIG. 2 shows the device when the holding member and the sheet are assembled and ready to be attached to e.g. a bridle of a horse, while FIG. 3 shows the device of the invention in a cross sectional view. FIG. 4 shows how the device can be attached to a bridle of a horse.

The adhesive is preferably a non-drying, tacky, adhesive substance which may be generally similar, for example, to that used on conventional sticky fly-paper, or on the tackier types of pressure-sensitive tape. A great deal of work has been done in the field of non-drying sticky coatings, so that suitable material is available for this purpose.

Applying for all Figures there is shown a device for catching insects, such as flies. The device comprises a sheet (1) having an inner and outer surface, wherein the outer surface is provided with an adhesive layer (3) for catching and holding insects contacting said adhesive; and a holding member (2) for holding the sheet and provided with means for attachment to an animal.

As shown in FIG. 4 the holding member (2) is clickable onto the bridle. This embodiment of the present invention is shown in more detail in FIGS. 1-3 showing the holding member (2) comprising an outer frame (4) for holding the sheet and an inner frame (5) for holding the holding member (2) in place on the bridle when the outer (4) and inner (5) frames are attached to each other, said inner (5) and outer (4) frames connected via a hinge (6). The holding member (2) is provided with protrusions having recesses (7) for clicking the sheet (1) onto the holding member (2). In order to ensure that the holding member (2) is held in the same position to the bridle when clamped around it the holding member (2) is provided with means (8) for securing it thereto. In the embodiment shown in the figures this is obtained by a flexible protrusion (8) that enhances the pressure exerted on the bridle by the outer (4) and inner (5) frames.

1. A device for catching insects, such as flies, said device comprising:
a sheet having an inner and outer surface, wherein the outer surface is provided with an adhesive layer for catching and holding insects contacting said adhesive;
a holding member for holding the sheet with the inner surface facing towards the holding member, said member provided with means for attachment to an animal, where the sheet is releasable from the holding member;
wherein the holding member is configured to be mounted onto a bridle, such as a cheek piece, of an animal, such as a horse, in the vicinity of the eyes, said holding member being clickable onto the bridle, said holding member comprising an outer frame for holding the sheet and an inner frame for holding the holding member in place on the bridle when the outer and inner frames are attached to each other, said inner and outer frames connected via a hinge.

2. The device of claim 1, wherein the sheet is clickable or slidable onto the holding member.

3. The device of claim 2, wherein the holding member is provided with protrusions having recesses for clicking the sheet onto the holding member.

4. The device of claim 2, wherein the holding member is provided with means for securing the holding member to the bridle when clamped around it.

5. The device of claim 4, wherein the means for securing the holding member to the bridle when clamped around it is based on flexible protrusions extending from the holding member towards the inner frame and thereby exerts force on the bridle when clamped around it.

6. The device of claim 1, wherein the adhesive comprises proteins to attract insects.

7. The device of claim 1, wherein the adhesive incorporates an insecticide for killing insects becoming affixed to the adhesive.

8. The device of claim 1, wherein the sheet is made from plastic, metal or plant fiber materials.
